(19) United States
(12) Patent Application Publication
(10) Pub. No.: US 2021/0222672 A1
(43) Pub. Date: Jul. 22, 2021

(54) SYSTEMS AND METHODS FOR OPERATION OF WIND TURBINES USING IMPROVED POWER CURVES

(71) Applicant: General Electric Company, Schenectady, NY (US)

(72) Inventors: SIYUN WANG, Shanghai (CN); Leonardo Cesar Kammer, Niskayuna, NY (US); Frederick Wilson Wheeler, Niskayuna, NY (US); Dhiraj Arora, Rexford, NY (US)

(21) Appl. No.: 16/744,498

(22) Filed: Jan. 16, 2020

(51) Int. Cl. F03D 7/02; F03D 7/04

(52) U.S. Cl. CPC F03D 7/028; F03D 7/042

(57) ABSTRACT

A wind turbine control system is disclosed. The wind turbine control system includes a wind turbine, at least one sensor configured to detect at least one environmental condition associated with the wind turbine, and a wind turbine controller communicatively coupled to the wind turbine and the at least one sensor. The wind turbine controller includes at least one processor in communication with at least one memory device. The at least one processor is configured to retrieve at least one wind condition variable associated with the wind turbine, retrieve a power curve, the power curve generated based on the at least one wind condition variable by computing, for each of a plurality of wind speed values, a power value, receive, from the at least one sensor, sensor data, and control the wind turbine using the generated power curve based on the received sensor data.

### BACKGROUND

The field of the invention relates generally to wind turbine control systems, and more particularly, to systems and methods for operation of wind turbines using improved power curves.

Most known wind turbines include a rotor having multiple blades. The rotor is sometimes coupled to a housing, or nacelle, that is positioned on top of a base, for example, a tubular tower. At least some known utility grade wind turbines, i.e., wind turbines designed to provide electrical power to a utility grid, have rotor blades having predetermined shapes and dimensions. The rotor blades transform kinetic wind energy into blade aerodynamic forces that induce a mechanical rotational torque to drive one or more generators, subsequently generating electric power.

Wind turbines are exposed to large variations in wind inflow, which exert varying loads on the wind turbine structure, particularly the wind turbine rotor and shaft. Some known wind turbines include sensor assemblies to detect characteristics of the wind such as direction and speed remotely. The detected wind characteristics may be used to control mechanical loads of the wind turbine. For example, based on a detected wind speed, the wind turbine may be controlled to operate at a particular output power. The output power is generally selected using a power curve. At least some known power curves are generally flat above a certain threshold wind speed. That is, when the current wind speed at a wind turbine is above a threshold level, the selected output power is constant with respect to wind speed. In at least some cases, controlling a wind turbine in this manner leads to suboptimal annual energy production (AEP), wind turbine lifetime, and/or other operating characteristics of the wind turbine. An improved control system for wind turbines is therefore desirable.

### BRIEF DESCRIPTION

In one aspect, a wind turbine control system is disclosed. The wind turbine control system includes a wind turbine, at least one sensor configured to detect at least one environmental condition associated with the wind turbine, and a wind turbine controller communicatively coupled to the wind turbine and the at least one sensor. The wind turbine controller includes at least one processor in communication with at least one memory device. The at least one processor is configured to retrieve at least one wind condition variable associated with the wind turbine, retrieve a power curve, the power curve generated based on the at least one wind condition variable by computing, for each of a plurality of wind speed values, a power value, receive, from the at least one sensor, sensor data, and control the wind turbine using the generated power curve based on the received sensor data.

In another aspect, a wind turbine controller is disclosed. The wind turbine controller is communicatively coupled to a wind turbine and at least one sensor configured to detect at least environmental condition associated with the wind turbine. The wind turbine controller includes at least one processor in communication with at least one memory device. The at least one processor is configured to retrieve at least one wind condition variable associated with the wind turbine, retrieve a power curve, the power curve generated based on the at least one wind condition variable by computing, for each of a plurality of wind speed values, a power value, receive, from the at least one sensor, sensor data, and control the wind turbine using the generated power curve based on the received sensor data.

In another aspect, a method for controlling a wind turbine using a wind turbine controller is disclosed. The wind turbine controller is communicatively coupled to a wind turbine and at least one sensor configured to detect at least environmental condition associated with the wind turbine. The wind turbine controller includes at least one processor in communication with at least one memory device. The method includes retrieving, by the wind turbine controller, at least one wind condition variable associated with the wind turbine, retrieving, by the wind turbine controller, a power curve, the power curve generated based on the at least one wind condition variable by computing, for each of a plurality of wind speed values, a power value, receiving, by the wind turbine controller, from the at least one sensor, sensor data, and controlling, by the wind turbine controller, the wind turbine using the generated power curve based on the received sensor data.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an exemplary wind turbine.

FIG. 2 is a block diagram of an exemplary wind turbine control system for use in controlling the wind turbine shown in FIG. 1.

FIG. 3 is a graph illustrating exemplary power curves that may be used for controlling the wind turbine shown in FIG. 1.

FIG. 4 is a flowchart of an exemplary method for controlling a wind turbine.

FIG. 5 is a flowchart of an exemplary method for generating a power curve.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The embodiments described herein include a wind turbine control system including a wind turbine, at least one sensor configured to detect at least one environmental condition associated with the wind turbine, and a wind turbine controller communicatively coupled to the wind turbine and the at least one sensor. The wind turbine controller includes at least one processor in communication with at least one memory device. The at least one processor is configured to retrieve at least one wind condition variable associated with the wind turbine, retrieve a power curve, the power curve generated based on the at least one wind condition variable by computing, for each of a plurality of wind speed values, a power value, receive, from the at least one sensor, sensor data, and control the wind turbine using the generated power curve based on the received sensor data.

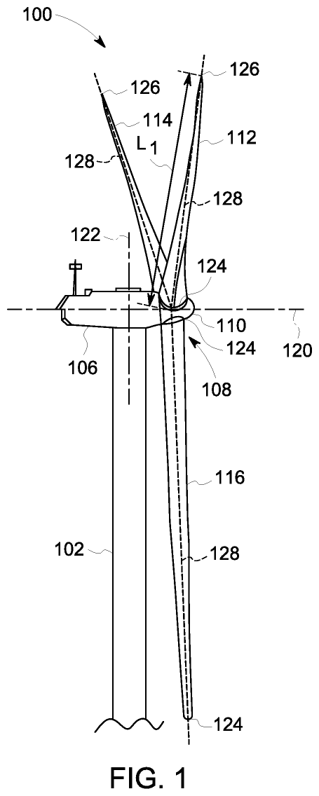

FIG. 1 is a schematic perspective view of an exemplary wind turbine 100. In the exemplary embodiment, wind turbine 100 is a horizontal axis wind turbine. Wind turbine 100 includes a tower 102 extending from a supporting surface (not shown), a nacelle 106 coupled to tower 102, and a rotor 108 coupled to nacelle 106. Rotor 108 has a rotatable hub 110 and a plurality of blades 112, 114, 116 coupled to rotatable hub 110. In the exemplary embodiment, rotor 108 has a first blade 112, a second blade 114, and a third blade 116. In alternative embodiments, rotor 108 has any number of blades 112, 114, 116 that enables wind turbine 100 to function as described herein. In the exemplary embodiment, tower 102 is fabricated from tubular steel and has a cavity (not shown in FIG. 1) extending between the supporting surface and nacelle 106. In alternative embodiments, wind turbine 100 includes any tower 102 that enables wind turbine 100 to operate as described herein. For example, in some embodiments, tower 102 is any one of a lattice steel tower, guyed tower, concrete tower and hybrid tower.

In the exemplary embodiment, blades 112, 114, 116 are positioned about rotatable hub 110 to facilitate rotating rotor 108 when wind flows through wind turbine 100. When rotor 108 rotates, kinetic energy from the wind is transferred into usable mechanical energy, and subsequently, electrical energy. During operation, rotor 108 rotates about a rotation axis 120 that is substantially parallel to the supporting surface. In addition, in some embodiments, rotor 108 and nacelle 106 are rotated about tower 102 on a yaw axis 122 to control the orientation of blades 112, 114, 116 with respect to the direction of wind. In alternative embodiments, wind turbine 100 includes any rotor 108 that enables wind turbine 100 to operate as described herein.

In the exemplary embodiment, each blade 112, 114, 116 is coupled to rotatable hub 110 at a hub end 124 and extends radially outward from rotatable hub 110 to a distal end 126. Each blade 112, 114, 116 defines a longitudinal axis 128 extending between hub end 124 and distal end 126. In alternative embodiments, wind turbine 100 includes any blade 112, 114, 116 that enables wind turbine 100 to operate as described herein.

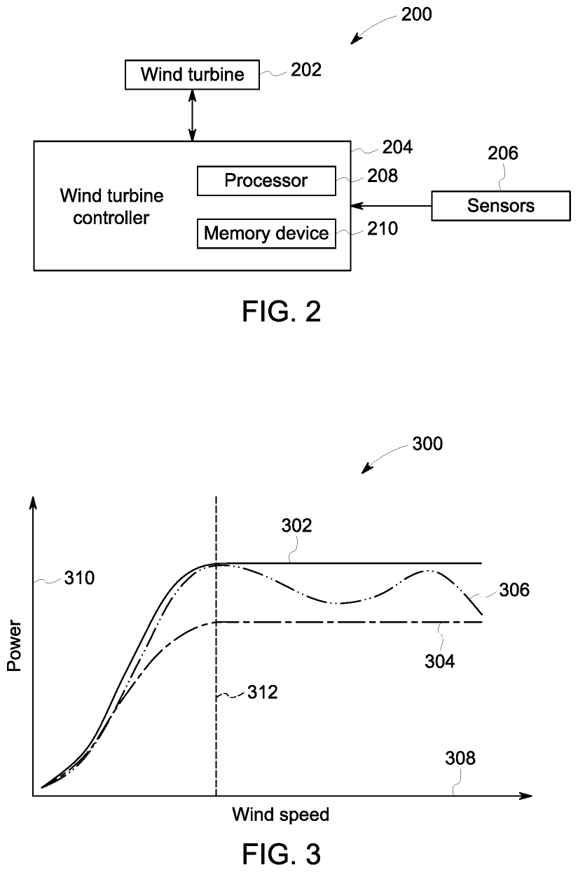

FIG. 2 is a block diagram of an exemplary wind turbine control system 200. Wind turbine control system 200 includes a wind turbine 202, a wind turbine controller 204, and one or more sensors 206. In some embodiments, wind turbine 202 is substantially similar to wind turbine 100 (shown in FIG. 1). Wind turbine controller 204 is communicatively coupled to wind turbine 202 and includes a processor 208 and a memory device 210. In some embodiments, at least some functionality of wind turbine controller 204 is performed by processor 208 and/or memory device 210.

Wind turbine 202 coverts kinetic wind energy into blade aerodynamic forces that induce a mechanical rotational torque that may be used to generate electric power. An amount of output power produced by wind turbine 202 depends on, for example, an amount of speed and/or torque of operation of wind turbine 202. In addition, other characteristics of wind turbine 202 may depend on the speed and/or torque of operation of wind turbine 202, such as a fatigue on components of wind turbine 202.

Wind turbine controller 204 controls the operation of wind turbine 202, for example, by controlling the speed, torque, thrust limit, cut-out wind speed, and/or other controller tuning parameters of wind turbine 202. For example, in some embodiments, wind turbine controller 204 may control a pitch angle of blades 112, 114, 116 (shown in FIG. 1), a yaw of wind turbine 202, a gearbox setting of wind turbine 202, and/or another operating parameter of wind turbine 202 that affects the speed and/or torque. By controlling the speed and/or torque of wind turbine 202, wind turbine controller 204 may select the output power at which wind turbine 202 operates.

In some embodiments, wind turbine controller 204 is configured to generate a power curve that may be used to control wind turbine 202. Additionally or alternatively, in some embodiments, wind turbine controller 204 is configured to retrieve the power curve, wherein the power curve has previously been generated by wind turbine controller 204 and/or another computing device. In some embodiments, the power curve may be generated based on, for example, environmental factors expected to be experienced by the wind turbine (sometimes referred to herein as “wind condition variables”) and variables expected to affect operation and/or a lifetime of the wind turbine (sometimes referred to herein as “operation variables”) such as, for example, fatigue loads, extreme loads, or gearbox loads. In some embodiments, wind turbine controller 204 computes, for each of a plurality of wind speed values, a corresponding power value. For example, in some embodiments, the power values are selected such that using the power curve increases an annual energy production (AEP) of the wind turbine without substantially decreasing a lifetime of the wind turbine. During operation of wind turbine 202, when one of the plurality of wind speeds is detected by sensors 206, wind turbine controller controls wind turbine 202 to operate at the corresponding power value using the generated power curve.

In some embodiments, to generate power curves, wind turbine controller 204 considers several wind condition variables that define environmental conditions that may be experienced by wind turbine 202, such as wind speed, turbulence intensity, air density, and/or other such factors. In some embodiments, a likelihood of particular values of wind condition variables will be experienced by wind turbine 202 is characterized by a wind condition probability distribution. Wind turbine controller 204 selects one or more such wind condition variables and discretizes the wind condition variables into a finite set of values, which enables wind turbine controller 204 to identify a finite set of possible combinations of the different wind condition variables (sometimes referred to herein as “wind condition variable combinations”). Wind turbine controller 204 computes operation variables, such as, for example, fatigue loads, extreme loads, and/or gearbox loads, for each of the identified wind condition variable combinations. In some embodiments, for each wind condition variable combination, the operation variable is computed at a plurality of different wind turbine operation points (e.g., different torques and/or speeds). Based on the computed operation variables and the wind condition probability distribution, in the exemplary embodiment, wind turbine controller 204 formulates a computational problem (e.g., an optimization problem) of maximizing AEP while meeting operation constraints such that the resulting computational problem is, for example, a mixed integer linear programming (MILP) problem. For example, the MILP problem generated to increase and/or maximize AEP subject to certain operation constraints may be:

max_{p(X)∈p}AEP=kΣ_{Π}_{ᵢ₌₁}_{^{N}}w(X)p(X) (Equation 1)

Subject to

S_{eq,s}^{m(s)}=kΣ_{Π}_{ᵢ₌₁}_{^{N}}w(X)S_{eq,s}^{m(s)}(X,p(X))≤S̅_{eq,s}^{m(s)}, ∀s∈SENSOR (Equation 2)

where discretized wind condition combinations are defined as Fᵢ={sᵢ₁, sᵢ₂, . . . , s_{i,n}_{ᵢ}}, i∈{1, 2, . . . , N} and Fᵢ⊂ [symbol] ᵢ, where nᵢ is a number of elements in Fᵢ, X∈Πᵢ₌₁^{N} Fᵢ, is defined as a discrete vector for all wind condition combinations, w(X) is defined as the probability distribution for X, the wind turbine operation points are defined as P={p₁, p₂, . . . , pₙ_{ₚ}} be a set of candidate wind turbine operation points, and p(X)∈P is defined as the wind turbine operation point under wind condition combination X. SENSOR is the set of all key sensor locations considered in the AEP optimization, S̅_{eq,s} is the designed upper bound for a damage equivalent load (DEL) or any other cumulative damage measure at a particular sensor s. The overall DEL can be calculated as:

$${𝒮}_{e q}^{m} = \frac{1}{{n}_{e q}} {\sum }_{i ′} {𝓃}_{i} ( 𝒳 , p ) {S}_{i}^{m} = \frac{1}{{n}_{e q}} {\sum }_{i} ( {\int }_{𝒳} 𝓌 ( 𝒳 ) {n}_{i} ( 𝒳 , p ) d 𝒳 ) {S}_{i}^{m} \qquad ( Equation 3 )$$

where nᵢ is the number of cycles at a particular wind condition combination and wind turbine operation point.

In some embodiments, to generate the power curve, the MILP problem is solved (e.g., by wind turbine controller 204 and/or another computing device) to generate one or more power curves. As will appreciated by those of skill in the art, MILP problems may be solved with various algorithms and software implementations. In some embodiments, the mixed integer linear problem is generated, for example, such that its solution power curves maximize and/or otherwise increase the AEP of wind turbine 202 subject to predefined limit constraints of the operation variables.

Once the one or more power curves have been generated, wind turbine controller 204 controls operation of wind turbine 202 using the one or more power curves, for example, by selecting a power curve based on wind speed and air density and using the selected power curve to determine an output power based on a current wind speed and a current air density. In some embodiments, controlling wind turbine 202 using the generated power curves may increase the AEP of wind turbine 202 relative to a flat power curve while reducing and/or minimizing any corresponding decrease in lifetime due to operating wind turbine 202 at a higher output power.

FIG. 3 is a graph 300 illustrating a first power curve 302, a second power curve 304, and a third power curve 306 that may be used for controlling wind turbine 100 (shown in FIG. 1). Graph 300 includes a horizontal axis 308 corresponding to a wind speed such as, for example, a wind speed detected at wind turbine 100. Graph 300 further includes a vertical axis 310 corresponding to an output power of wind turbine 100. The output power of wind turbine 100 may be selected based on a current wind speed using, for example, first power curve 302, second power curve 304, or third power curve 306.

The output power, when selected based on first power curve 302 or second power curve 304, generally increases as wind speed increases until a threshold wind speed 312 is reached, after which the output power remains constant. Controlling wind turbine 100 based on first power curve 302 generally results in a higher output power, and a correspondingly higher AEP, than controlling wind turbine 100 based on second power curve 304. Conversely, in some embodiments, controlling wind turbine 100 based on second power curve 304 generally results in lower fatigue, and a correspondingly longer operating lifetime of wind turbine 100, than controlling wind turbine 100 based on first power curve 302. In some embodiments, third power curve 306 is a power curve generated by wind turbine controller 204 using the systems and methods described herein, and controlling wind turbine 100 using third power curve 306 increases an AEP of wind turbine 100 while minimally increasing a fatigue of wind turbine 100.

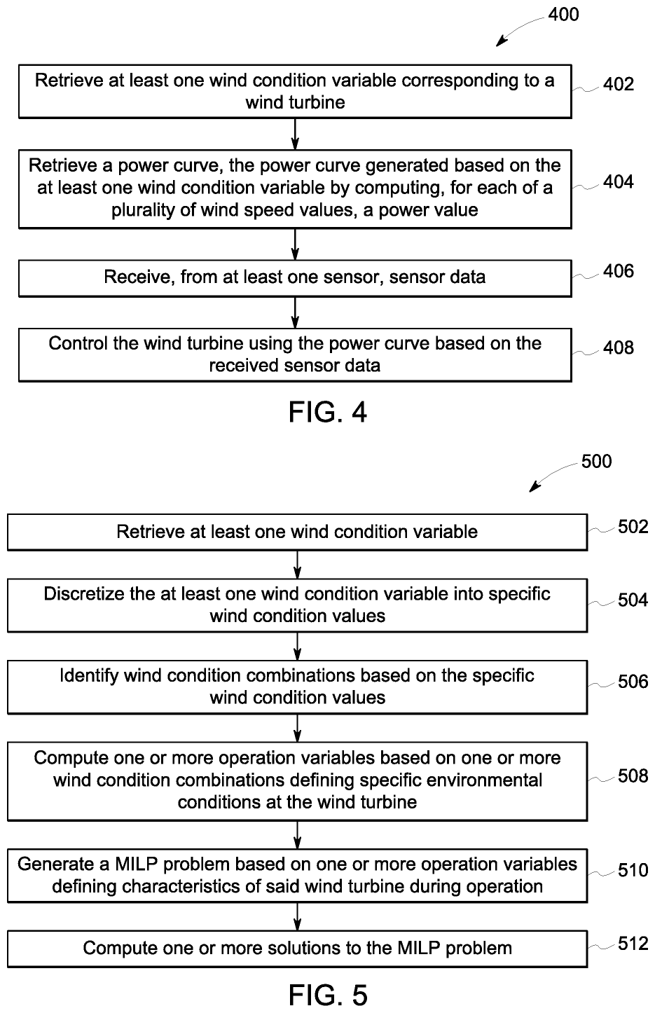

FIG. 4 illustrates an exemplary method 400 for controlling wind turbine 202. In some embodiments, method 400 is performed by wind turbine controller 204. Method 400 includes retrieving 402 at least one wind condition variable corresponding to wind turbine 202. Method 400 further includes retrieving 404 a power curve, the power curve generated based on the at least one wind condition variable by computing, for each of a plurality of wind speed values, a power value. Method 400 further includes receiving 406, from at least one sensor (such as sensors 206), sensor data. Method 400 further includes controlling 408 wind turbine 202 using the power curve based on the received sensor data.

FIG. 5 illustrates an exemplary method 500 for generating a power curve to control wind turbine 100. In some embodiments, method 500 is performed by wind turbine controller 204. Method 500 includes retrieving 502 a at least one wind condition variable. Method 500 further includes discretizing 504 the at least one wind condition variable into specific wind condition values. Method 500 further includes identifying 506 wind condition combinations based on the specific wind condition values. Method 500 further includes computing 508 one or more operation variables based on one or more wind condition combinations defining specific environmental conditions at the wind turbine. Method 500 further includes generating 510 an MILP problem based on one or more operation variables defining characteristics of the wind turbine during operation. Method 500 further includes compute one or more solutions to the MILP problem.

An exemplary technical effect of the methods, systems, and apparatus described herein includes at least one of: (a) improving an AEP of a wind turbine by controlling the wind turbine using a power curve based on environmental conditions at the wind turbine; (b) improving AEP of a wind turbine relative to a lifetime of the wind turbine by controlling the wind turbine using a power curve computed based on environmental conditions at the wind turbine; and (c) improving efficiency of generating a power curve by computing the power curve based on environmental conditions at the wind turbine, a probability distribution corresponding to the environmental conditions, and operation variables of the wind turbine.

Exemplary embodiments of a system for controlling a wind turbine are provided herein. The systems and methods of operating and manufacturing such systems and devices are not limited to the specific embodiments described herein, but rather, components of systems and/or steps of the methods may be utilized independently and separately from other components and/or steps described herein. For example, the methods may also be used in combination with other electronic systems, and are not limited to practice with only the electronic systems, and methods as described herein. Rather, the exemplary embodiment can be implemented and utilized in connection with many other electronic systems.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A wind turbine control system comprising:
a wind turbine;
at least one sensor configured to detect at least one environmental condition associated with said wind turbine; and
a wind turbine controller communicatively coupled to said wind turbine and said at least one sensor, said wind turbine controller comprising at least one processor in communication with at least one memory device, said at least one processor configured to:
retrieve at least one wind condition variable associated with said wind turbine;
retrieve a power curve, the power curve generated based on the at least one wind condition variable by computing, for each of a plurality of wind speed values, a power value;
receive, from said at least one sensor, sensor data; and
control said wind turbine using the generated power curve based on the received sensor data.

2. The wind turbine control system of claim 1, wherein said at least one processor is further configured to generate the power curve.

3. The wind turbine control system of claim 2, wherein to generate the power curve, said at least one processor is configured to:
generate a computational problem that increases an annual energy production (AEP) of said wind turbine; and
compute one or more solutions to the computational problem.

4. The wind turbine control system of claim 3, wherein the computational problem is a mixed integer linear programming (MILP) problem.

5. The wind turbine control system of claim 3, wherein to generate the computational problem, said at least one processor is configured to generate the computational problem based on one or more operation variables defining characteristics of said wind turbine during operation.

6. The wind turbine control system of claim 5, wherein the operating variables include at least one of a fatigue load, an extreme load, and a gearbox load of said wind turbine.

7. The wind turbine control system of claim 5, wherein to generate the computational problem, said at least one processor is further configured to compute the one or more operation variables based on one or more wind condition combinations defining specific environmental conditions at said wind turbine.

8. The wind turbine control system of claim 7, wherein to compute the one or more operation variables, said at least one processor is configured to:
discretize the at least one wind condition variable into specific wind condition values; and
identify the one or more wind condition combinations based on the specific wind condition values.

9. The wind turbine control system of claim 8, wherein to generate the computational problem, said at least one processor is further configured to generate the computational problem further based on a probability distribution of the wind condition variables.

10. A wind turbine controller communicatively coupled to a wind turbine and at least one sensor configured to detect at least one environmental condition associated with the wind turbine, said wind turbine controller comprising at least one processor in communication with at least one memory device, said at least one processor configured to:
retrieve at least one wind condition variable associated with the wind turbine;
retrieve a power curve, the power curve generated based on the at least one wind condition variable by computing, for each of a plurality of wind speed values, a power value;
receive, from the at least one sensor, sensor data; and
control the wind turbine using the generated power curve based on the received sensor data.

11. The wind turbine controller of claim 10, wherein said at least one processor is further configured to generate the power curve.

12. The wind turbine controller of claim 11, wherein to generate the power curve, said at least one processor is configured to:
generate a computational problem that increases an annual energy production (AEP) of said wind turbine; and
compute one or more solutions to the computational problem.

13. The wind turbine controller of claim 13, wherein the computational problem is a mixed integer linear programming (MILP) problem.

14. The wind turbine controller of claim 12, wherein to generate the computational problem, said at least one processor is configured to generate the computational problem based on one or more operation variables defining characteristics of the wind turbine during operation.

15. The wind turbine controller of claim 14, wherein the operating variables include at least one of a fatigue load, an extreme load, and a gearbox load of said wind turbine.

16. The wind turbine controller of claim 14, wherein to generate the computational problem, said at least one processor is further configured to compute the one or more operation variables based on one or more wind condition combinations defining specific environmental conditions at the wind turbine.

17. The wind turbine controller of claim 16, wherein to compute the one or more operation variables, said at least one processor is configured to:
discretize the at least one wind condition variable into specific wind condition values; and
identify the one or more wind condition combinations based on the specific wind condition values.

18. The wind turbine controller of claim 16, wherein to generate the computational problem, said at least one processor is further configured to generate the computational problem further based on a probability distribution of the wind condition variables.

19. A method for controlling a wind turbine using a wind turbine controller communicatively coupled to the wind turbine and at least one sensor configured to detect at least one environmental condition associated with the wind turbine, the wind turbine controller including at least one processor in communication with at least one memory device, said method comprising:
retrieving, by the wind turbine controller, at least one wind condition variable associated with the wind turbine;
retrieving, by the wind turbine controller, a power curve, the power curve generated based on the at least one wind condition variable by computing, for each of a plurality of wind speed values, a power value;
receiving, by the wind turbine controller, from the at least one sensor, sensor data; and
controlling, by the wind turbine controller, the wind turbine using the generated power curve based on the received sensor data.

20. The method of claim 19, further comprising generating, by the wind turbine controller, the power curve.
